(19) United States
(12) Patent Application Publication
(10) Pub. No.: US 2005/0059349 A1
(43) Pub. Date: Mar. 17, 2005

(54) Systems and methods for indicating quality of wireless connection

(76) Inventor: Brig Barnum Elliott, Arlington, MA (US)

Correspondence Address: ROPES & GRAY LLP, ONE INTERNATIONAL PLACE, BOSTON, MA, 02110-2624, US

(21) Appl. No.: 10/663,922

(22) Filed: Sep. 16, 2003

(51) Int. Cl. H04B 17/00

(52) U.S. Cl. 455/67.7; 455/67.11; 455/67.13

(57) ABSTRACT

A wireless device (110) includes a transceiver (230), an output queue (220), indicator logic (250, 510), and an indicator (260). The transceiver (230) is configured to transmit data to a network via a wireless connection. The output queue (220) is configured to store data that awaits transmission by the transceiver (230). The indicator logic (250, 510) is configured to estimate the quality of the wireless connection based on queuing behavior of the data and/or transceiver behavior relating to the data. The indicator (260) is configured to provide information regarding the quality of the wireless connection to a user of the wireless device (110).

### BACKGROUND OF THE INVENTION

1. Field of the Invention

The present invention relates generally to wireless communication and, more particularly, to systems and methods for providing an indication of the quality of a wireless connection.

2. Description of Related Art

Cellular telephones have long been used to provide voice communication. Parties using cellular telephones can readily determine when their cellular connection degrades because they are actively monitoring the conversation. When the cellular connection degrades, the quality of the voice communication degrades as well, typically to the point where the communication becomes unintelligible. To resolve this problem, the parties often move (e.g., to a window, to face a different direction, outside, down the sidewalk, etc.) until the cellular connection improves.

There is currently no equivalent indicator for wireless Internet connectivity either within a wireless local area network (LAN), such as a wireless 802.11 LAN, or in metro wireless deployments. As a result, it is often a mystery to wireless device users whether the problem is with the wireless connection or elsewhere in the Internet. Sometimes, an action so simple as turning the wireless device so that its antenna faces a different direction can make a major difference in the quality of the wireless connection.

As a result, there is a need for an indicator that informs the wireless device user of the quality of the wireless connection.

### SUMMARY OF THE INVENTION

Systems and methods consistent with the principles of the invention provide a simple indicator to a wireless device user of the quality of the wireless connection. If the connection degrades, then the user may move, redirect the antenna of the wireless device, or give up. Otherwise, the user need not do anything.

In one aspect consistent with the principles of the invention, a wireless device includes a transceiver, an output queue, indicator logic, and an indicator. The transceiver is configured to transmit data to a network via a wireless connection. The output queue is configured to store data that awaits transmission by the transceiver. The indicator logic is configured to estimate the quality of the wireless connection based on queuing behavior of the data and/or transceiver behavior relating to the data. The indicator is configured to provide information regarding the quality of the wireless connection to a user of the wireless device.

According to another aspect, a wireless device includes a transceiver, an output queue, indicator logic, and an indicator. The transceiver is configured to transmit data to a network via a wireless connection. The output queue is configured to store data that awaits transmission by the transceiver. The indicator logic is configured to estimate the quality of the wireless connection based on the amount of time that the data remains in the output queue. The indicator is configured to provide information regarding the quality of the wireless connection to a user of the wireless device.

According to yet another aspect, a method for providing information regarding a wireless connection to a user of a wireless device is provided. The method includes temporarily storing packets that await transmission via the wireless connection; estimating a quality of the wireless connection based on an amount of time that the packets are temporarily stored; and providing information regarding the quality of the wireless connection to the user of the wireless device.

According to a further aspect, a system for providing information relating to a current state of a wireless connection used by a wireless device is provided. The system includes measurement logic, a quality estimator, and an indicator. The measurement logic is configured to read a first time at which a packet that awaits transmission via the wireless connection is stored in a queue, read a second time at which the packet is dequeued from the queue, and determine the amount of time that the packet remains in the queue based on a difference between the first and second times. The quality estimator is configured to generate a statistical measure of the amount of time that a plurality of packets remain in the queue and estimate the current state of the wireless connection based on the statistical measure. The indicator is configured to present information regarding the current state of the wireless connection to a user of the wireless device.

According to another aspect, a wireless device includes a transceiver, indicator logic, and an indicator. The transceiver is configured to transmit data to a network via a wireless connection. The indicator logic is configured to estimate the quality of the wireless connection based on an amount of time that it takes the transceiver to successfully transmit the data. The indicator is configured to provide information regarding the quality of the wireless connection to a user of the wireless device.

According to yet another aspect, a method for providing information regarding a wireless connection to a user of a wireless device is provided. The method includes transmitting packets via the wireless connection; estimating the quality of the wireless connection based on an amount of time that it takes to successfully transmit the packets; and providing information regarding the quality of the wireless connection to the user of the wireless device.

According a further aspect, a system for providing information relating to a current state of a wireless connection used by a wireless device is provided. The system includes measurement logic, a quality estimator, and an indicator. The measurement logic is configured to measure a time interval from a time when transmission of packets begins until a time when confirmation of successful transmission of the packets is received. The quality estimator is configured to generate a statistical measure of an amount of time that it takes to successfully transmit the packets and estimate the current state of the wireless connection based on the statistical measure. The indicator is configured to present information regarding the current state of the wireless connection to a user of the wireless device.

### BRIEF DESCRIPTION OF THE DRAWINGS

The accompanying drawings, which are incorporated in and constitute a part of this specification, illustrate the invention and, together with the description, explain the invention. In the drawings,

FIG. 1 is a diagram of a system in which systems and methods consistent with the present invention may be implemented;

FIG. 2 is an exemplary diagram of a wireless device of FIG. 1 according to an implementation consistent with the principles of the invention;

FIG. 3 is an exemplary diagram of the indicator logic of FIG. 2 according to an implementation consistent with the present invention;

FIG. 4 is a flowchart of exemplary processing for providing an indication of a quality of a wireless connection according to an implementation consistent with the principles of the invention; and

FIG. 5 is an exemplary diagram of a wireless device of FIG. 1 according to an alternate implementation consistent with the principles of the invention.

### DETAILED DESCRIPTION

The following detailed description of the invention refers to the accompanying drawings. The same reference numbers in different drawings may identify the same or similar elements. Also, the following detailed description does not limit the invention. Instead, the scope of the invention is defined by the appended claims and equivalents.

Systems and methods consistent with the present invention provide a simple indicator to a wireless device user of the quality of the wireless connection. If the connection is poor, then the user may take remedial action. Otherwise, the user need not do anything.

### Exemplary System

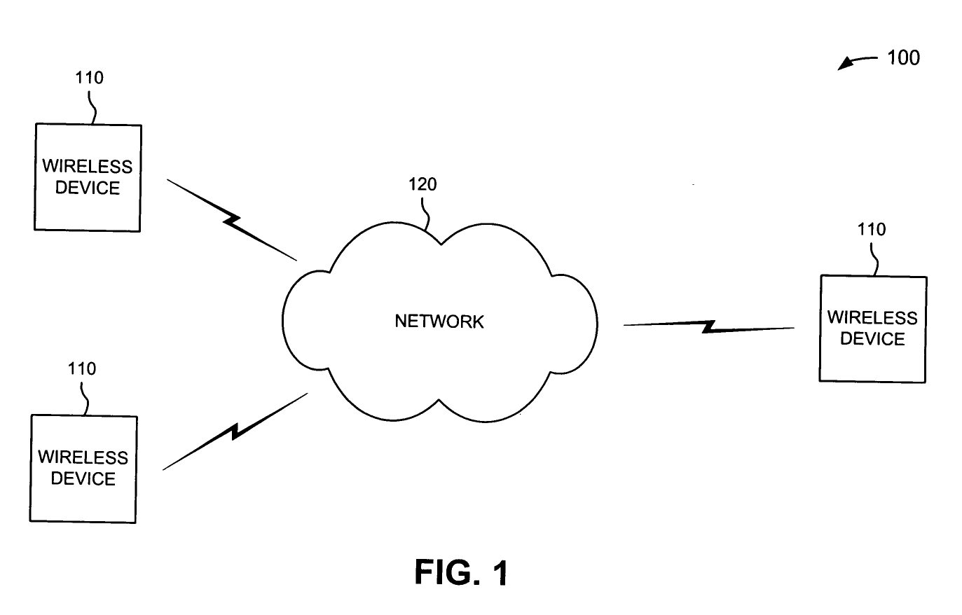

FIG. 1 is a diagram of an exemplary system 100 in which systems and methods consistent with the present invention may be implemented. System 100 may include a number of wireless devices 110 connected to a network 120 via one or more wireless connections. Network 120 may include the Internet, an intranet, the Public Switched Telephone Network (PSTN), a LAN, a wide area network (WAN), a different type of network, or a combination of networks. While FIG. 1 shows three wireless devices 110 connected to network 120, in practice, there may be more or fewer wireless devices 110.

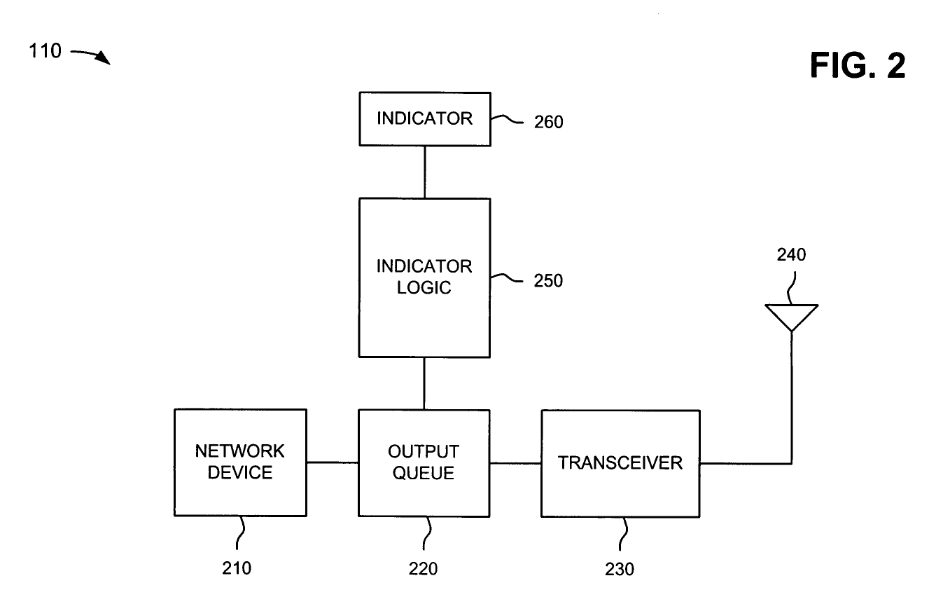

A wireless device 110 may include any device capable of communicating over network 120. Thus, wireless device 110 may take many different forms. FIG. 2 is one exemplary diagram of a wireless device 110 according to an implementation consistent with the principles of the invention. Wireless device 110 may include a network device 210, output queue 220, transceiver 230, antenna 240, indicator logic 250, and indicator 260.

Network device 110 may include any type of device capable of communicating via a network, such as network 120. Examples of network devices include computers, wireless telephones, personal digital assistants (PDAs), pagers, and other types of handheld or portable devices. Output queue 220 may include a memory that stores packet data, or non-packet data, that awaits transmission from wireless device 110. Output queue 220 may be configured as a first-in, first-out (FIFO) memory or in another arrangement that specifies treatment of packets to be transmitted by transceiver 230.

Transceiver 230 may include a wireless transmitter/receiver. Transceiver 230 may be radio-based as used, for example, in cellular telephone systems, wireless 802.11 LANs, wireless fidelity (WiFi) networks, and BlueTooth networks. Alternatively, transceiver 230 may be based on infra-red light or other wireless communication techniques. Antenna 240 may include an omni-directional or directional antenna.

Indicator logic 250 may generate information regarding the quality of the current wireless connection of wireless device 110. Indicator logic 250 may use this information to determine the state of indicator 260. Indicator logic 250 may be implemented in software, hardware, or a combination of hardware and software. For example, indicator logic 250 and indicator 260 may be implemented within network device 210.

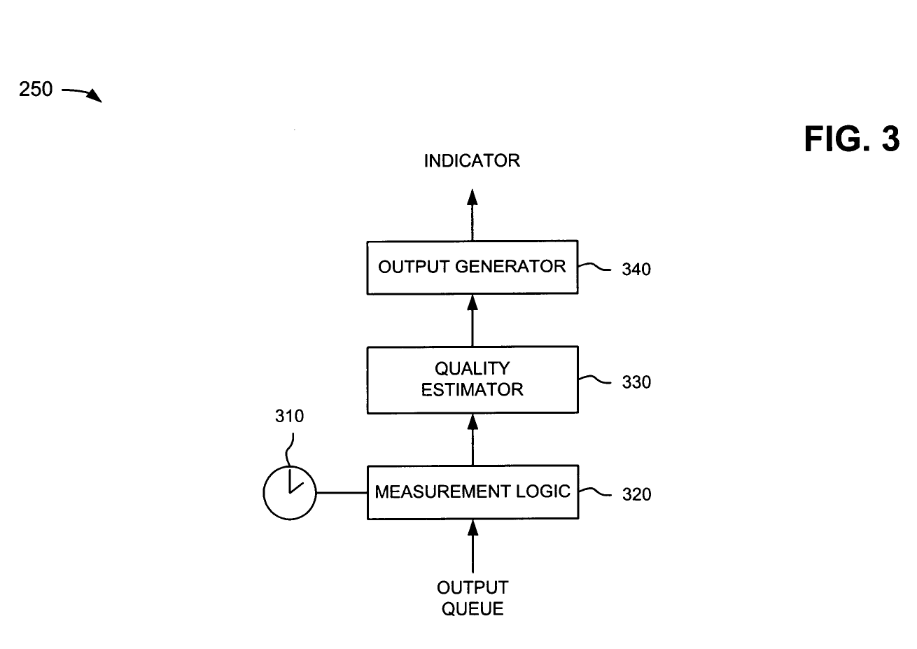

FIG. 3 is an exemplary functional block diagram of indicator logic 250 according to an implementation consistent with the principles of the invention. Indicator logic 250 may include clock 310, measurement logic 320, quality estimator 330, and output generator 340. Clock 310 may include a local oscillator that measures time. Clock 310 need not be synchronized to any other clock either within or outside of wireless device 110.

Measurement logic 320 may determine how long (in time) packets remain in output queue 220 before being dequeued by transceiver 230. Measurement logic 320 may make this determination by reading clock 310 when a packet is stored in output queue 220 and reading clock 310 again when the packet is dequeued by transceiver 230. The difference between the two clock readings may indicate the duration of the packet in output queue 220.

Quality estimator 330 may estimate the current state of the wireless connection (e.g., the quality of the wireless connection (or link)). Because any given wireless device 110 may send a variable number of packets per second, some kind of time-based statistics on a series of transmission attempts may be more indicative of the current state of the wireless connection rather than a determination of the time that a single packet remained in output queue 220. Quality estimator 330 may generate a rolling statistical measure of how long packets have remained in output queue 220 in “recent” history (e.g., some predetermined period of time, such as the last X milliseconds, seconds, or minutes). For example, quality estimator 330 may determine the mean delay for the last N transmissions, median delay for the last N transmissions, mean delay in the last N seconds, median delay in the last N seconds, a certain percentile (e.g., 80th percentile) instead of median, or some other type of statistical determination.

Output generator 340 may cause indicator 260 to reflect the current state of the wireless connection based on the output of quality estimator 330. For example, if the statistical measure generated by quality estimator 330 indicates a degraded wireless connection (e.g., the data remains in output queue 220 more than some predetermined (threshold) amount of time), then output generator 340 may set indicator 260 to reflect this degraded state. Output generator 340 may classify the wireless connection state into one of a set of predetermined states, such as poor, fair, and good wireless connections, or generate other information indicative of the current state of the wireless connection.

Returning to FIG. 2, indicator 260 may take many different forms. For example, indicator 260 may include a visual mechanism, an audible mechanism, and/or a physical mechanism. Examples of visual mechanisms might include one or more light emitting diodes (LEDs), such as red, yellow, and green LEDs that may respectively indicate poor, fair, and good wireless connections, or a pixel display, such as visual display on a monitor of wireless device 110 that may explicitly indicate the state of the wireless connection. For example, indicator 260 may be implemented in a pop-up window, or some other type of software-type display, that is under user control or pops up when the wireless connection degrades.

The audible mechanism might provide any type of audible signal, such as an audio message or tone. The physical mechanism might provide a physical indication of the state of the wireless connection. For example, the physical mechanism may include components that cause wireless device 110 to shake when the wireless connection degrades. One of ordinary skill would realize that other forms of indicators 260 are also possible.

### Exemplary Processing

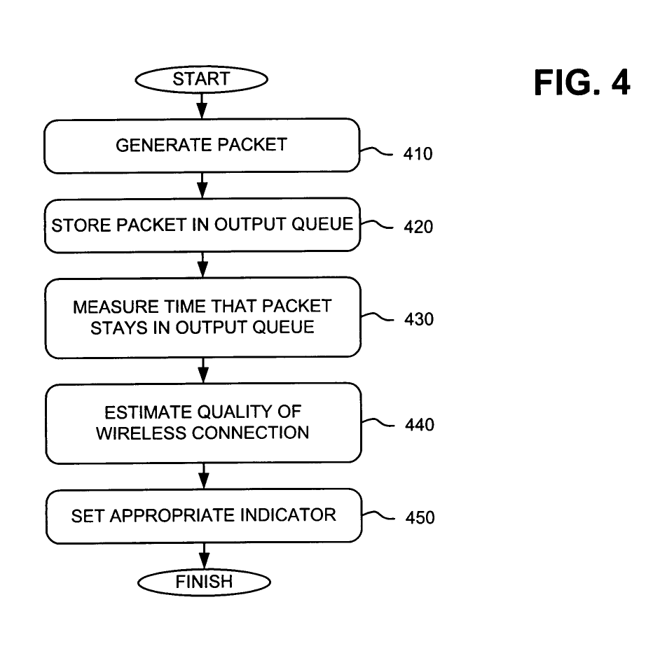

FIG. 4 is a flowchart of exemplary processing for providing an indication of a quality of a wireless connection according to an implementation consistent with the principles of the invention. The discussion to follow will be provided in terms of the transmission of packets. It is to be understood that the discussion equally applies to the transmission of non-packet data as well.

Processing may begin with network device 210 of wireless device 110 generating data, such as a packet, to be transmitted on a network, such as network 120, via a wireless connection (act 410). Network device 210 may store the packet at an appropriate place in output queue 220 (act 420).

Once the packet is stored in output queue 220, transceiver 230 may attempt to obtain access on a wireless communication channel to network 120. Once it obtains channel access, transceiver 230 may try to transmit the packet. If transceiver 230 receives acknowledgment of a successful transmission, transceiver 230 may dequeue the packet from output queue 220. Otherwise, transceiver 230 may periodically retry the packet transmission for some period of time. Eventually, transceiver 230 may discard the packet if it does not obtain an acknowledgment to any of its prior transmission attempts.

Indicator logic 250 may notice the storage of the packet in output queue 220 and measure the amount of time that the packet remains in output queue 220 (act 430). For example, indicator logic 250 may read clock 310 (FIG. 3) at the time when the packet is stored in output queue 220 and read clock 310 again at the time when the packet is dequeued by transceiver 230. The difference between these two clock readings may indicate the amount of time that the packet remained in output queue 220. The particular amount of time that a packet remains in output queue 220 may generally depend on factors, such as the length (or size) of output queue 220 and the rate at which packets are stored in output queue 220 and dequeued from output queue 220.

Indicator logic 250 may then estimate the quality of the wireless connection (act 440). For example, indicator logic 250 may determine a rolling statistical measure of the time that packets remain in output queue 220. Indicator logic 250 may perform some statistical calculation (e.g., determining the mean delay for the last N transmissions, median delay for the last N transmissions, mean delay in the last N seconds, median delay in the last N seconds, a certain percentile instead of median, or some other type of statistical determination) for packets stored in output queue 220 within recent history.

Indicator logic 250 may then cause indicator 260 to reflect the current state of the wireless connection based on the estimated quality of the wireless connection. For example, if the statistical measure indicates a degraded wireless connection (e.g., the data remains in output queue 220 more than some predetermined (threshold) amount of time), then indicator 260 may be set to reflect this degraded state. If indicator 260 includes a visual mechanism, then indicator 260 may visually represent the current state of the wireless connection in some manner to the user. If indicator 260 includes an audible mechanism, then indicator 260 may audibly represent the current state of the wireless connection to the user. If indicator 260 includes a physical mechanism, then indicator 260 may cause network device 210 to identify the current state of the wireless connection to the user. For example, indicator 260 may cause the shaking of network device 210 to indicate a poor wireless connection.

In addition to information regarding the current state of the wireless connection, indicator logic 250 may provide other information to the user that the user may find useful. For example, indicator logic 250 may provide information regarding the rate at which the packets are sent (e.g., 11 megabits/second, 2 megabits/second, 500 kilobits/second, etc.) or information relating to the received signal strength. If desired, this information can be factored into the estimation of the current state of the wireless connection.

### Alternative Exemplary System

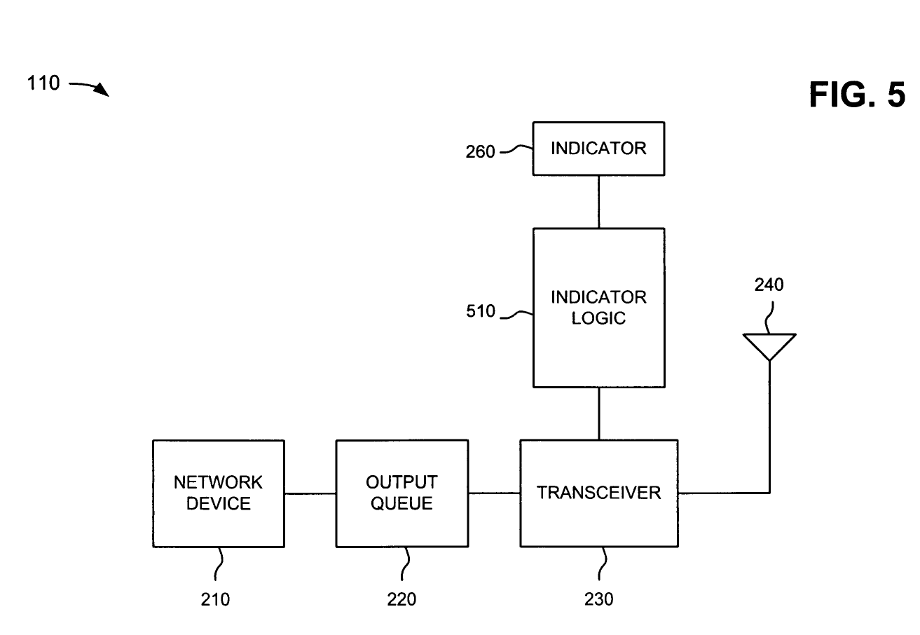

FIG. 5 is an exemplary diagram of a wireless device 110 according to an alternative implementation consistent with the principles of the invention. According to this implementation, wireless device includes network device 210, output queue 220, transceiver 230, antenna 240, indicator logic 510, and indicator 260. Network device 210, output queue 220, transceiver 230, antenna 240, and indicator 260 may be configured similar to those same components described above with regard to FIG. 2.

Instead of measuring queuing behavior, indicator logic 510 may measure time intervals relating to the behavior of transceiver 230. For example, assume that the wireless connection is associated with a wireless 802.11 LAN. When an 802.11 wireless device (“initiator”) wants to transmit data, such as a packet, it first sends a Request to Send (RTS) message to the intended recipient. If the recipient is not otherwise busy and the channel is free near the recipient, then the recipient may reply with a Clear to Send (CTS) message back to the initiator. The initiator may then send the packet. If the recipient receives it correctly and can demodulate it without error, the recipient replies with an acknowledgment (ACK) that completes the transaction.

When a channel is congested, the initiator may have to send several RTS messages before it receives a CTS message. There are rules for how long the initiator must wait between sending RTS messages. If there is sufficient interference, the recipient may get errors when receiving the packet and, therefore, will not be able to send an ACK back to the initiator. In these cases, the whole transaction must start over again. Thus, in congested or interfered networks, it can take quite a while from transmission of the first RTS message until receipt of the ACK by the initiator.

Indicator logic 510, in this example, may measure this time interval—from the time that the first RTS is sent for a given packet until the time that the ACK is finally received for the packet (or until the packet is discarded because too many failures have occurred). Indicator logic 510 may use this time interval, instead of the queue occupancy time, in estimating the current state of the wireless connection.

### Conclusion

Systems and methods consistent with the present invention provide a simple indicator to a wireless device user of the quality of the wireless connection. If the connection is poor, then the user may take remedial action, such as moving the wireless device or changing the direction of the antenna. Otherwise, the user need not do anything.

A good high-level indicator of how well a wireless connection is working is to see how well packets traverse the connection. From the vantage point of a specific wireless device, it is difficult to determine how the network is behaving in general. In fact, it is difficult to determine how well the wireless connection is operating at getting packets to the wireless device from a network access node. It is possible to measure, however, how well the wireless connection transmits packets from the wireless device to the access node because wireless connections generally provide some form of acknowledgment when a packet is successfully transmitted from one device to another.

In wireless networks that are uncongested and without interference (i.e., those that are generally working well), the entire transmission process can be relatively fast. In those networks with a great deal of contention, or interference that causes lost packets and retransmissions, a given packet may reside in an output queue for a fairly long period of time and take a long time to successfully transmit. Thus, the quality of a wireless connection can be estimated based on how well a wireless device is able to transmit packets. As described above, the capability to transmit packets can be measured based on queuing behavior and/or transceiver behavior.

The foregoing description of preferred embodiments of the present invention provides illustration and description, but is not intended to be exhaustive or to limit the invention to the precise form disclosed. Modifications and variations are possible in light of the above teachings or may be acquired from practice of the invention.

For example, implementations have been described above as estimating the quality of a wireless connection based on a measurement of queuing behavior or transceiver behavior. In other implementations, the quality of a wireless connection can be estimated based on a combination of measurements of queuing behavior and transceiver behavior.

Also, while a series of acts has been described with regard to FIG. 4, the order of the acts may differ in other implementations consistent with the principles of the invention.

Further, certain portions of the invention have been described as “logic” that performs one or more functions. This logic may include hardware, such as an application specific integrated circuit or a field programmable gate array, software, or a combination of hardware and software.

No element, act, or instruction used in the description of the present application should be construed as critical or essential to the invention unless explicitly described as such. Also, as used herein, the article “a” is intended to include one or more items. Where only one item is intended, the term “one” or similar language is used. The scope of the invention is defined by the claims and their equivalents.

1. A wireless device, comprising:
a transceiver configured to transmit data to a network via a wireless connection;
an output queue configured to store data that awaits transmission by the transceiver;
indicator logic configured to estimate a quality of the wireless connection based on an amount of time that the data remains in the output queue; and
an indicator configured to provide information regarding the quality of the wireless connection to a user of the wireless device.

2. The wireless device of claim 1, wherein the indicator logic includes:
measurement logic configured to:
read a first time at which data is stored in the output queue,
read a second time at which the data is dequeued by the transceiver, and
determine an amount of time that the data remains in the output queue based on a difference between the first and second times.

3. The wireless device of claim 1, wherein the indicator logic includes:
a quality estimator configured to:
generate a statistical measure of an amount of time that data remains in the output queue, and
use the statistical measure to estimate the quality of the wireless connection.

4. The wireless device of claim 3, wherein the statistical measure is generated for data stored in the output queue over a predetermined period of time.

5. The wireless device of claim 1, wherein the indicator includes a visual mechanism that provides a visual indication of the quality of the wireless connection to the user.

6. The wireless device of claim 1, wherein the indicator includes an audible mechanism that provides an audible signal relating to the quality of the wireless connection to the user.

7. The wireless device of claim 1, wherein the indicator includes a physical mechanism that provides a physical indication relating to the quality of the wireless connection to the user.

8. The wireless device of claim 1, wherein the network is the Internet.

9. A wireless device, comprising:
means for transmitting packets to a network via a wireless link;
means for temporarily storing packets that await transmission on the wireless link;
means for estimating a quality of the wireless link based on an amount of time that the packets are temporarily stored; and
means for providing information regarding the quality of the wireless link to a user of the wireless device.

10. A method for providing information regarding a wireless connection to a user of a wireless device, the method comprising:
queuing packets that await transmission via the wireless connection;
estimating a quality of the wireless connection based on an amount of time that the packets are queued; and
providing information regarding the quality of the wireless connection to the user of the wireless device.

11. The method of claim 10, wherein the estimating a quality of the wireless connection includes:
reading a first time at which a packet is queued,
reading a second time at which the packet is dequeued, and
determining an amount of time that the packet is queued based on a difference between the first and second times.

12. The method of claim 10, wherein the estimating a quality of the wireless connection includes:
generating a statistical measure of an amount of time that the packets are queued, and
using the statistical measure to estimate the quality of the wireless connection.

13. The method of claim 12, wherein the statistical measure is generated for packets that are queued over a predetermined period of time.

14. The method of claim 10, wherein the providing information regarding the quality of the wireless connection includes:
presenting a visual indication of the quality of the wireless connection to the user.

15. The method of claim 10, wherein the providing information regarding the quality of the wireless connection includes:
presenting an audible signal relating to the quality of the wireless connection to the user.

16. The method of claim 10, wherein the providing information regarding the quality of the wireless connection includes:
presenting a physical indication relating to the quality of the wireless connection to the user.

17. A system for providing information relating to a current state of a wireless connection used by a wireless device, comprising:
measurement logic configured to:
read a first time at which a packet that awaits transmission via the wireless connection is stored in a queue,
read a second time at which the packet is dequeued from the queue, and
determine an amount of time that the packet remained in the queue based on a difference between the first and second times;
a quality estimator configured to:
generate a statistical measure of the amount of time that a plurality of packets remained in the queue, and
estimate the current state of the wireless connection based on the statistical measure; and
an indicator configured to present information regarding the current state of the wireless connection to a user of the wireless device.

18. The system of claim 17, wherein the statistical measure is generated for packets stored in the queue over a predetermined period of time.

19. The system of claim 17, wherein the indicator includes a visual mechanism that provides a visual indication of the current state of the wireless connection to the user.

20. The system of claim 17, wherein the indicator includes an audible mechanism that provides an audible signal relating to the current state of the wireless connection to the user.

21. The system of claim 17, wherein the indicator includes a physical mechanism that provides a physical indication relating to the current state of the wireless connection to the user.

22. A wireless device, comprising:
a transceiver configured to transmit data to a network via a wireless connection;
indicator logic configured to estimate a quality of the wireless connection based on an amount of time that it takes the transceiver to successfully transmit the data; and
an indicator configured to provide information regarding the quality of the wireless connection to a user of the wireless device.

23. The wireless device of claim 22, wherein the indicator logic includes:
measurement logic configured to measure a time interval from a time when the transceiver begins to transmit the data until a time when the transceiver receives confirmation of a successful transmission of the data.

24. The wireless device of claim 22, wherein the indicator logic includes:
a quality estimator configured to:
generate a statistical measure of an amount of time that it takes the transceiver to successfully transmit data, and
use the statistical measure to estimate the quality of the wireless connection.

25. The wireless device of claim 24, wherein the statistical measure is generated for data transmitted over a predetermined period of time.

26. The wireless device of claim 22, wherein the indicator includes a visual mechanism that provides a visual indication of the quality of the wireless connection to the user.

27. The wireless device of claim 22, wherein the indicator includes an audible mechanism that provides an audible signal relating to the quality of the wireless connection to the user.

28. The wireless device of claim 22, wherein the indicator includes a physical mechanism that provides a physical indication relating to the quality of the wireless connection to the user.

29. The wireless device of claim 22, wherein the network is the Internet.

30. A wireless device, comprising:
means for transmitting packets to a network via a wireless link;
means for estimating a quality of the wireless link based on an amount of time that it takes to successfully transmit the packets; and
means for providing information regarding the quality of the wireless link to a user of the wireless device.

31. A method for providing information regarding a wireless connection to a user of a wireless device, the method comprising:
transmitting packets via the wireless connection;
estimating a quality of the wireless connection based on an amount of time that it takes to successfully transmit the packets; and
providing information regarding the quality of the wireless connection to the user of the wireless device.

32. The method of claim 31, wherein the estimating a quality of the wireless connection includes:
measuring a time interval from a time when transmission of the packets begins until a time when confirmation of a successful transmission of the packets is received.

33. The method of claim 31, wherein the estimating a quality of the wireless connection includes:
generating a statistical measure of an amount of time that it takes to successfully transmit packets, and
using the statistical measure to estimate the quality of the wireless connection.

34. The method of claim 33, wherein the statistical measure is generated for packets that are transmitted over a predetermined period of time.

35. The method of claim 31, wherein the providing information regarding the quality of the wireless connection includes:
presenting a visual indication of the quality of the wireless connection to the user.

36. The method of claim 31, wherein the providing information regarding the quality of the wireless connection includes:
presenting an audible signal relating to the quality of the wireless connection to the user.

37. The method of claim 31, wherein the providing information regarding the quality of the wireless connection includes:
presenting a physical indication relating to the quality of the wireless connection to the user.

38. A system for providing information relating to a current state of a wireless connection used by a wireless device, comprising:
measurement logic configured to measure a time interval from a time when transmission of packets begins until a time when confirmation of successful transmission of the packets is received;
a quality estimator configured to:
generate a statistical measure of an amount of time that it takes to successfully transmit the packets, and
estimate the current state of the wireless connection based on the statistical measure; and
an indicator configured to present information regarding the current state of the wireless connection to a user of the wireless device.

39. The system of claim 38, wherein the statistical measure is generated for packets transmitted over a predetermined period of time.

40. The system of claim 38, wherein the indicator includes a visual mechanism that provides a visual indication of the current state of the wireless connection to the user.

41. The system of claim 38, wherein the indicator includes an audible mechanism that provides an audible signal relating to the current state of the wireless connection to the user.

42. The system of claim 38, wherein the indicator includes a physical mechanism that provides a physical indication relating to the current state of the wireless connection to the user.

43. A wireless device, comprising:
a transceiver configured to transmit data to a network via a wireless connection;
an output queue configured to store data that awaits transmission by the transceiver;
indicator logic configured to estimate a quality of the wireless connection based on at least one of queuing behavior of the data and transceiver behavior relating to the data; and
an indicator configured to provide information regarding the quality of the wireless connection to a user of the wireless device.

44. The wireless device of claim 43, wherein the queuing behavior relates to an amount of time that the data remains in the output queue before being dequeued by the transceiver.

45. The wireless device of claim 43, wherein the transceiver behavior relates to an amount of time that it takes for the transceiver to successfully transmit the data.
